(19) United States
(12) Patent Application Publication
(10) Pub. No.: US 2024/0108011 A1
(43) Pub. Date: Apr. 4, 2024

(54) HERBICIDAL COMBINATIONS AND COMPOSITIONS AND METHODS FOR TREATING WEEDS USING THE SAME

(71) Applicants: UPL Corporation Limited, Port Louis (MU); UPL Europe LTD, Warrington (GB)

(72) Inventors: Vicente Gongora, Durham, NC (US); Carlos Eduardo Fabri, Campinas (BR); Ayrton Berger Neto, Campinas (BR)

(21) Appl. No.: 18/566,831

(22) PCT Filed: Jun. 10, 2022
(86) PCT No.: PCT/IB2022/055414

§ 371 Date: Dec. 4, 2023

Related U.S. Application Data
(60) Provisional application No. 63/209,102, filed on Jun. 10, 2021.

(51) Int. Cl. A01N 57/20; A01N 37/38; A01P 13/00

(52) U.S. Cl. CPC A01N 57/20; A01N 37/38; A01P 13/00

(57) ABSTRACT

Herbicidal combinations and compositions generally include L-glufosinate or a salt thereof, and a choline salt of 2,4-D. Also disclosed are methods of controlling weeds using the same.

### CROSS REFERENCE TO RELATED APPLICATIONS

The present application claims the benefit under 35 U.S.C. § 119(e) of U.S. Provisional Application No. 63/209,102, filed on Jun. 10, 2021, which is incorporated herein by reference in its entirety.

### FIELD OF INVENTION

The present invention relates to a combination of herbicides. More specifically, the present invention relates to herbicidal combinations comprising L-glufosinate or a salt thereof, and a choline salt of 2,4-D. The present invention also relates to an herbicidal composition comprising L-glufosinate or a salt thereof, and a choline salt of 2,4-D and methods of controlling weeds using the same.

### BACKGROUND

Herbicides are pesticides useful for killing or controlling unwanted plants. Generally, there are two kinds of herbicides—selective and non-selective. Selective herbicides kill certain target weeds while leaving the desired crop relatively unharmed, while non-selective herbicides kill both the weeds and crops. Profitable crop production depends on effective weed control as weeds can reduce field crop yields by competing with crops for water, sunlight, and nutrients. In today's crop production systems, a good burn-down program is a must as it helps to achieve maximum initial crop growth and reduce weed interference during early stages of the crop cycle. Since the weed-crop competition is critical during the early stages of the crop cycle, the weed interference at an early stage has a direct impact on the yield of the crop.

An effective weed control can be achieved by appropriate use of herbicides. The activity of herbicides can be enhanced in various ways to achieve the maximum benefit. One of the ways to enhance activity is to use combinations. However, identifying appropriate combinations, their agrochemical application rates, and the ratio of the combination of agents is essential to achieve efficacious control. The selection of a particular formulation type is more cumbersome for an agrochemical combination. Thus, herbicides play an important role for weed control in crop production. Applying combinations of herbicidal compounds may enhance the herbicidal effectiveness.

Glufosinate (phosphinothricin; DL-homoalanin-4-yl(methyl)phosphinic acid) is a racemic phosphinico amino acid. Its ammonium salt (glufosinate-ammonium) is widely used as a non-selective herbicide and is an active ingredient of many commercial herbicide formulations. The herbicidally active L-isomer of glufosinate is a structural analogue of glutamate and, therefore, is a competitive inhibitor of the enzyme glutamine synthetase (GS) of bacteria and plants. The D-isomer is not a GS inhibitor and is not herbicidally active.

Due to the inhibition of GS by glufosinate, non-tolerant plant cells accumulate large amounts of toxic ammonia produced by nitrate assimilation and photorespiration, and the level of available glutamine drops. Damage to cell membranes and inhibition of photosynthesis are followed by plant cell death. The action of glufosinate is dependent on environmental conditions. Temperatures below 10° C., as well as drought stress, reduce its efficacy because of the limited metabolic activity of the plant. Also, light is an important factor for the action of glufosinate.

Glufosinate is a contact herbicide and is taken up by the plant primarily through the leaves. There is no uptake from the soil through the roots, presumably because of the rapid degradation of glufosinate by soil micro-organisms. There is also limited translocation of glufosinate within the plant. Glufosinate has a wide spectrum of activity encompassing monocotyledonous and dicotyledonous species. However, due to its limited systemic action, there is no enduring effect on perennial weeds. Hoechst et al., in 1991, reported examples of weed species that are not, or only weakly, combated by glufosinate are Viola arvensis, Bromus spp., Lolium spp., Agropyron repens and Urtica urens. Moreover, weeds emerging after herbicide application are not affected.

In addition to showing prominent herbicidal effects on a wide spectrum of weeds, the L-isomer of glufosinate can be used by micro-organisms as a source of nitrogen and is subject to microbial degradation. Fast dissipation of the DL-racemic mixture was found in all soils investigated under laboratory, as well as field conditions by (Dorn E., Goerlitz G., Heusel R., Stumpf K. (1992): Verhalten von Glufosinat-ammonium in der Umwelt—Abbau und Einfluss auf das Oekosystem, Z Pflanzenkrankh Pflanzenschutz, Sonderheft 13, 459-468; Smith, A. E. 1989. Transformation of the herbicide [14C]-glufosinate-ammonium in soils. J. Agric. Food Chem. 37, 267-271).

2,4-dichlorophenoxyacetic acid (2,4-D) is a phenoxyacetic acid herbicide that is used post-emergence for selective control of broadleaf weeds. The herbicide kills weeds by disrupting plant hormone responses. It is a systemic herbicide which selectively kills most broadleaf weeds by causing uncontrolled growth in them, while most grasses such as cereals, lawn turf, and grassland are relatively unaffected.

### OBJECTS OF THE DISCLOSURE

With limitations on individual efficacies of the existing herbicides in terms of activity and target, there was an underlying need for an effective combination which overcomes the previously known shortcomings of the solo active ingredients. There remains a great need for improved broadleaf and grassy weed control compositions and a method of controlling such noxious vegetation in pre- and post-emergence crops without adversely affecting desirable plants, and which reduces the amount of chemical herbicidal agent necessary to obtain the acceptable weed control.

Thus, it is an objective of the present disclosure to provide a combination for efficient weed control, weed suppression and eradication.

It is another object of the present disclosure to provide a synergistic herbicidal combination to control, suppress or prevent a wide spectrum of weeds and target plants, both dicotyledonous and monocotyledonous, broad-leaved, and grassy weeds.

It is yet another object of the present disclosure to provide an herbicidal combination which is safe to use, effective and can be applied pre-emergence, post-emergence or at the time of sowing.

It is also an object of the present disclosure to provide an herbicidal composition for control of a wide spectrum of weeds and target plants, both dicotyledonous and monocotyledonous, broad-leaved and grassy weeds.

It is an object of the present disclosure to provide a method of controlling or killing weeds with a synergistic herbicidal combination or a composition comprising such a combination.

Additionally, it is an object of the disclosure to provide a method of controlling resistant varieties of weeds with a suitable herbicidal mixture.

### SUMMARY

An aspect of the present disclosure hereby provides a combination of an isomer of glufosinate or a salt thereof, and a choline salt of 2,4-D. The isomer of glufosinate can be the L isomer of glufosinate.

Additionally, an aspect of the present disclosure provides a synergistic combination of L-glufosinate or a salt thereof, and a choline salt of 2,4-D.

Another aspect of the present disclosure provides a composition comprising a combination of L-glufosinate or a salt thereof, and a choline salt of 2,4-D.

An aspect of the present disclosure provides a composition comprising L-glufosinate or a salt thereof, a choline salt of 2,4-D and an agrochemically acceptable excipient.

An aspect of the present disclosure also provides a process of preparing a composition comprising L-glufosinate or a salt thereof, and a choline salt of 2,4-D.

Another aspect of the disclosure provides a method of controlling weeds comprising applying to a locus a combination comprising L-glufosinate or a salt thereof, and a choline salt of 2,4-D. The combination is synergistic in its effect towards the weeds.

An aspect also provided is a method of controlling weeds comprising applying to a locus a composition comprising L-glufosinate or a salt thereof, and a choline salt of 2,4-D.

Yet another aspect provides use of a combination comprising L-glufosinate or a salts thereof, and a choline salt of 2,4-D for effective control of weeds. The combination was found to possess synergistic effects at the locus of a plant.

An aspect of the disclosure also provides a kit-of-parts comprising a component of L-glufosinate or a salt thereof and another component of a choline salt of 2,4-D. The components may be mixed at the time of application as per the given set of instructions.

### DETAILED DESCRIPTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about” and is meant to encompass variations of ±10%, ±5%, ±1%, ±0.5%, or even ±0.1% of the specified value as well as the specified value.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

It should be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

The term “herbicide” as used herein means an active ingredient that kills, controls or otherwise adversely modifies the growth of plants. As used herein, a herbicidally effective or vegetation controlling amount is an amount of active ingredient that causes a “herbicidal effect,” i.e., an adversely modifying effect and includes deviations from natural development, killing, regulation, desiccation, retardation, and methods known to a person skilled in the art.

The terms “plants” and “vegetation” include, but are not limited to, germinant seeds, emerging seedlings, plants emerging from vegetative propagules, and established vegetation. The term “weed” refers to unwanted vegetation and includes any plant which grows where it is not wanted, including pesticide resistant plants. In the broadest sense, the term “weed” refers to plants which grow in locations in which they are not desired. In other words, a “weed” is a plant in which in the context of a crop is undesirable due to competition with the crop for water, nutrients, sunlight, soil, etc. The term may also refer to crop plants which are undesirable at a particular location.

The terms “undesirable vegetation”, “harmful plants”, “unwanted plants”, “weeds” and “weed species”, as used herein, are synonyms.

Typically, the combinations/compositions of the present invention are applied to the targeted weeds or to their locus or to the crop/plant. The term “locus” of a crop/plant as used herein shall denote the vicinity of a desired crop in which weed control, typically selective weed control is desired. The locus includes the vicinity of desired crop plants, wherein the weed infestation has either emerged or is yet to emerge. The term “crop” shall include a multitude of desired crop plants or an individual crop plant growing at a locus. The locus could be a weed, an area adjacent to the weed, soil adapted to support growth of the weed, a root of the weed and/or foliage of the weed.

In any aspect or embodiment described hereinbelow, the phrase “comprising” may be replaced by the phrases “consisting of” or “consisting essentially of” or “consisting substantially of”. In these aspects or embodiments, the combination or composition described includes or comprises or consists of or consists essentially of or consists substantially of the specific components recited therein, to the exclusion of other herbicides or fungicides or insecticide or plant growth promoting agents or adjuvants, or excipients not specifically recited therein.

In the present invention, surprising and unexpected advantages on combining L-glufosinate with a choline salt of 2,4-D have been found to provide an efficient and synergistic solution for weed control.

As used herein, the terms “choline salt of 2,4-D” and “2,4-D choline” are synonymous and interchangeable. The 2,4-D choline is a quaternary ammonium salt, which is different from prior 2,4-D amine or ester formulations. 2,4-D choline retains the positive attributes of traditional 2,4-D products, such as the same weed control efficacy and favourable environmental profile, while providing growers new advantages for the management of resistant and hard-to-control weeds. Moreover, tit has been found that 2,4-D choline is less prone to drift and volatilization than other forms of 2,4-D.

An embodiment provides an herbicidal combination comprising an isomer of glufosinate or a salt thereof, and a choline salt of 2,4-D. The isomer of glufosinate may be selected from the group consisting of the L isomer, P isomer, and D isomer of glufosinate. In one or more embodiments, the isomer is an L isomer of glufosinate. The glufosinate herbicide in the combination may be present in a salt form. Non-limiting examples of salt forms of glufosinate are glufosinate ammonium, glufosinate sodium, and the like. The choice of the specific salt form is not intended to be limiting.

According to an embodiment, the isomer of glufosinate or a salt thereof is an L isomer of glufosinate or a salt thereof. Non-limiting examples of salt forms of L-glufosinate are L-glufosinate ammonium, L-glufosinate sodium, L-glufosinate potassium and so the like. The choice of the specific salt form is not intended to be limiting.

An embodiment provides an herbicidal combination of an L isomer of glufosinate or a salt thereof, and a choline salt of 2,4-D.

An embodiment provides an herbicidal combination of L-glufosinate and a choline salt of 2,4-D.

As used herein, the term “L-glufosinate” or “L isomer of glufosinate” are synonymous and interchangeable and also includes salts and ester forms of L-glufosinate. The L isomer of glufosinate is a structural analogue of glutamate and, therefore, is a competitive inhibitor of the enzyme glutamine synthetase (GS) in bacteria and plants. The L isomer, also called as L enantiomer, of glufosinate acts by inhibition of glutamine synthetase thereby causing accumulation of toxic levels of ammonium ion and indirectly stopping photosynthesis. It is also known as phosphinothricin or (S)-2-amino-4-(hydroxy(methyl)phosphonoyl)butanoic acid. The term L-glufosinate can generically refer to any form of L-glufosinate such as solvates, hydrates, esters, anhydrous form, polymorphic forms, pseudo polymorphic forms, amorphous form or mixture thereof, and sodium, potassium or ammonium salts.

The salts of L-glufosinate such as monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, and —NH₂(CH₃)(C₂H₄OH)⁺ salt are included in the definition. The agronomically acceptable salts include L-glufosinate-ammonium, L-glufosinate-sodium, and L-glufosinate-potassium. The term may also refer to an isomeric (racemic) mixture of L-glufosinate, D-glufosinate and salts thereof, wherein the content of L-glufosinate in the mixture is 70% or greater, preferably 80% or greater and more preferably 90% or greater. Typically, the ratio of L-glufosinate:D-glufosinate can be in the range from about 95:5 to about 99.9:0.1.

According to an embodiment, glufosinate or L-glufosinate or a salt thereof is an herbicide of the organophosphate herbicide class.

According to an embodiment, glufosinate or L-glufosinate or a salt thereof is an herbicide of the glutamine synthetase inhibitor herbicide class.

According to an embodiment, a choline salt of 2,4-D is an herbicide of the phenoxyacetic herbicide class.

According to an embodiment, a choline salt of 2,4-D is an herbicide of the auxin herbicide class.

According to an embodiment, the combination is a synergistic combination. In various embodiments, the herbicidal activity of a combination according to the present disclosure exceeds the total of the activities of the individual active compounds. For the two active compounds in a combination, or when applied together so as to form a combination, the activity will be greater than the sum of the activities of the single active compounds alone. Thus, in various embodiments, herbicidal combinations include combinations that are synergistic for control of one or more weeds.

The use of the combinations/compositions according to the present disclosure provides for excellent herbicidal effectiveness against a broad spectrum of economically important mono- and dicotyledonous annual weeds and perennial weeds.

According to another embodiment, the present disclosure provides an herbicidal combination of L-glufosinate or a salt thereof, and a choline salt of 2,4-D.

According to another embodiment, the present disclosure provides a synergistic herbicidal combination of L-glufosinate or a salts thereof, and a choline salt of 2,4-D.

Exemplary salts of L-glufosinate are L-glufosinate-ammonium (also called glufosinate-P-ammonium), which is ammonium (2S)-2-amino-4-(methylphosphinato)butyric acid (CAS Reg. No. 73777-50-1); L-glufosinate-sodium (also called glufosinate-P-sodium), which is sodium (2S)-2-amino-4-(methylphosphinato)butyric acid (CAS Reg. No. 70033-13-5) and L-glufosinate-potassium (also called glufosinate-P-potassium), which is potassium (2S)-2-amino4-(methylphosphinato)butyric acid.

As per an embodiment, the L-glufosinate salt is L-glufosinate ammonium.

As per an embodiment, the L-glufosinate salt is L-glufosinate sodium.

As per an embodiment, the L-glufosinate salt is L-glufosinate potassium.

According to an embodiment, glufosinate isomer or a salt thereof and choline salt of 2,4-D are admixed in a ratio of 1000:1 to 1:1000. Specifically, the two active compounds are combined in a ratio of 750:1 to 1:750.

According to an embodiment L-glufosinate or salts thereof and choline salt of 2,4-D are admixed in a ratio of 1000:1 to 1:1000. Specifically, the two active compounds are combined in a ratio of 750:1 to 1:750.

According to an embodiment, L-glufosinate or salts thereof and choline salt of 2,4-D are admixed in a ratio of 500:1 to 1:500.

According to an embodiment, L-glufosinate or salts thereof and choline salt of 2,4-D are admixed in a ratio of 250:1 to 1:250.

According to an embodiment, L-glufosinate or salts thereof and choline salt of 2,4-D are admixed in a ratio of 100:1 to 1:100.

According to an embodiment, L-glufosinate or salts thereof and choline salt of 2,4-D are admixed in a ratio of 75:1 to 1:75.

According to an embodiment, L-glufosinate or salts thereof and choline salt of 2,4-D are admixed in a ratio of 50:1 to 1:50.

According to an embodiment, L-glufosinate or salts thereof and choline salt of 2,4-D are admixed in a ratio of 25:1 to 1:25.

According to an embodiment, L-glufosinate or salts thereof and choline salt of 2,4-D are admixed in a ratio of 10:1 to 1:10.

According to an embodiment, L-glufosinate or salts thereof and choline salt of 2,4-D are admixed in a ratio of 5:1 to 1:5.

According to an embodiment, the present disclosure provides an herbicidal composition comprising an isomer of glufosinate selected from L-glufosinate, P-glufosinate, D-glufosinate or a salt thereof, and a choline salt of 2,4-D.

An embodiment of the present disclosure provides an herbicidal composition comprising L-glufosinate or a salt thereof, and a choline salt of 2,4-D.

An embodiment of the present disclosure provides an herbicidal composition comprising a synergistic herbicidal combination of L-glufosinate or a salt thereof and a choline salt of 2,4-D.

In another embodiment, said composition further includes an agrochemically acceptable excipient.

In an embodiment, the total amount of L-glufosinate or a salt thereof in the composition may typically be in the range of about 0.1% to about 99% by total weight of the composition. The total amount of choline salt of 2,4-D in the composition may be in the range of about 0.1% to about 99% by total weight of the composition, preferably.

In an embodiment, the constituent herbicides of the composition of the present invention may be admixed in ratio of (1000):(1) to (1):(1000) of the L-glufosinate or a salt thereof and a choline salt of 2,4-D, respectively.

According to an embodiment, L-glufosinate is added as its ammonium salt to the composition.

In an embodiment, the amount of L-glufosinate or salts thereof in the combinations or compositions of the present invention may range from about 100 to 1000 g active ingredient/liter (ai/L).

In an embodiment, the amount of L-glufosinate or salts thereof in the combinations or compositions of the present invention may range from about 1 to 1000 g ai/L.

In an embodiment, the amount of L-glufosinate or salts thereof in the combinations or compositions of the present invention may range from about 10 to 1000 g ai/L.

In an embodiment, the amount of L-glufosinate or salts thereof in the combinations or compositions of the present invention may range from about 50 to 1000 g ai/L.

In an embodiment, the amount of L-glufosinate or salts thereof in the combinations or compositions of the present invention may range from about 100 to 500 g ai/L.

In an embodiment, the amount of L-glufosinate or salts thereof in the combinations or compositions of the present invention may range from about 180 to 380 g ai/L.

In an embodiment, the amount of L-glufosinate or salts thereof in the combinations or compositions of the present invention may range from about 250 to 300 g ai/L.

In one preferred embodiment, in combinations or compositions of the present disclosure, L-glufosinate or salts thereof is present in an amount of about 280 g ai/L.

In an embodiment, the amount of choline salt of 2,4-D in the combinations or compositions of the present invention may range from about 1 to 2000 g ai/L.

In an embodiment, the amount of choline salt of 2,4-D in the combinations or compositions of the present invention may range from about 10 to 2000 g ai/L.

In an embodiment, the amount of choline salt of 2,4-D in the combinations or compositions of the present invention may range from about 50 to 2000 g ai/L.

In an embodiment, the amount of choline salt of 2,4-D in the combinations or compositions of the present invention may range from about 100 to 2000 g ai/L.

In an embodiment, the amount of choline salt of 2,4-D in the combinations or compositions of the present invention may range from about 100 to 1000 g ai/L.

In an embodiment, the amount of choline salt of 2,4-D in the combinations or compositions of the present invention may range from about 200 to 800 g ai/L.

In an embodiment, the amount of choline salt of 2,4-D in the combinations or compositions of the present invention may range from about 300 to 600 g ai/L.

In one preferred embodiment, in combinations or compositions of the present disclosure, choline salt of 2,4-D is present in an amount of about 456 g ai/L.

In an embodiment, there is provided a composition comprising L-glufosinate, a choline salt of 2,4-D, and an agrochemically acceptable excipient.

The agrochemically acceptable excipient may be any one or a combination of adjuvants, co-solvents, surfactants, colorants, dispersants, emulsifiers, thickeners, antifreeze agents, biocides, antifoam agents, stabilizers, wetting agents, or a mixture thereof.

Exemplary surfactants include non-ionic, anionic and cationic surfactants.

Examples of nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C₈-C₂₂ alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol, and mixtures thereof.

Examples of anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C₁₂-C₁₅ alkanols or polyalkoxylated C₁₂-C₁₅alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates, and phosphated alkyl phenol ethoxylates.

Cationic surfactants include, but are not limited to, alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈-C₁₈ fatty amine polyalkoxylates.

Emulsifiers, which can be advantageously employed herein, can be readily determined by those skilled in the art, include various non-ionic, anionic, cationic and amphoteric emulsifiers, or a blend of two or more emulsifiers. Examples of nonionic emulsifiers useful in preparing emulsifiable concentrates, for example, include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers, and salts of phosphated polyglycol ether.

In an embodiment, colorants may include, but are not limited to, iron oxide, titanium oxide and Prussian Blue, and organic dyestuffs, such as alizarin dyestuffs, azo dyestuffs, and metal phthalocyanine dyestuffs, and trace elements, such as salts of iron, manganese, boron, copper, cobalt, molybdenum, and zinc.

Exemplary thickeners and binders include, but are not limited to, molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, and polyglycols.

In another embodiment, exemplary antifreeze agent(s) include comprising, but are not limited to, ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, and octaglycerol.

According to an embodiment, exemplary biocides include, but are not limited to, benzothiazoles, 1,2-benzisothiazolin-3-one, sodium dichloro-s-triazinetrione, sodium benzoate, potassium sorbate, 1,2-phenyl-isothiazolin-3-one, and inter chloroxylenol paraoxybenzoate butyl.

According to an embodiment, antifoam agents include, but are not limited to, polydimethoxysiloxane, polydimethylsiloxane, alkyl poly acrylates, castor oil, fatty acids, fatty acid esters, fatty acid sulfates, fatty alcohols, fatty alcohol esters, fatty alcohol sulfates, olive oil, mono and di glycerides, paraffin oil, paraffin wax, polypropylene glycol, silicone oil, vegetable fats, vegetable fat sulfates, vegetable oil, vegetable oil sulfates, vegetable wax, vegetable wax sulfates, and agents based on silicon or magnesium stearate.

Exemplary additives to be used for the formulation include, for example, a solid carrier such as kaolinite, sericite, diatomaceous earth, slaked lime, calcium carbonate, talc, white carbon, kaoline, bentonite, clay, sodium carbonate, sodium bicarbonate, mirabilite, zeolite or starch; a solvent such as water, toluene, xylene, solvent naphtha, dioxane, dimethylsulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenylether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or a salt of alkylnaphthalene sulfonic acid condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins. These additives may suitably be selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be employed.

The agrochemical formulations may also comprise one or more antioxidants. Preferably, the agrochemical formulation comprises an antioxidant. Exemplary antioxidants are, for example, amino acids (e.g., glycine, histidine, tyrosine, tryptophan) and derivatives thereof, imidazole and imidazole derivatives (e.g., urocanic acid), peptides, such as, for example, D,L-carnosine, D-carnosine, L-carnosine and derivatives thereof (e.g., anserine), carotenoids, carotenes (e.g., α-carotene, β-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthionine sulfoximines, homocysteine sulfoximine, buthionine sulfones, penta-, hexa-, heptathionine sulfoximine) in very low tolerated doses (e.g., pmol/kg to pmol/kg), also metal chelating agents (e.g., α-hydroxy fatty acids, ethylenediaminetetraacetic acid (EDTA), ethylene glycol-bis(β-aminoether)-N,N,N′,N′-tetraacetic acid (EGTA), phytic acid, lactoferrin), α-hydroxy acids (e.g. citric acid, lactic acid, malic acid), humic acids, bile acid, bile extracts, gallic esters (e.g., propyl, octyl and dodecyl gallate), flavonoids, catechins, bilirubin, biliverdin and derivatives thereof, unsaturated fatty acids and derivatives thereof (e.g., γ-linolenic acid, linoleic acid, arachidonic acid, oleic acid), folic acid and derivatives thereof, hydroquinone and derivatives thereof (e.g., arbutin), ubiquinone and ubiquinol, and derivatives thereof, vitamin C and derivatives thereof (e.g., ascorbyl palmitate, stearate, dipalmitate, acetate, magnesium ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g., selenomethionine), stilbenes and stilbene derivatives (e.g., stilbene oxide, trans-stilbene oxide).

According to the invention, suitable derivatives (salts, esters, sugars, nucleotides, nucleosides, peptides and lipids) and mixtures of these specified active ingredients or plant extracts (e.g., teatree oil, rosemary extract and rosemarinic acid) which comprise these antioxidants can be used. In general, mixtures of the aforementioned antioxidants are possible.

According to an embodiment, examples of solvents include, but are not limited to, water, aromatic solvents (for example, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example, methanol, butanol, pentanol, benzyl alcohol, cyclohexanol), ketones (for example, cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

According to an embodiment, suitable surfactants include, but are not limited to, alkali metal, alkaline earth metal and ammonium salts of lignosulfonic acid, naphthalenesulfonates, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

According to an embodiment, examples of carriers include, but are not limited to, mineral earths such as silica gels, silicates, talc, kaolin, attaclay, attapulgite, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders, polyvinylpyrrolidone and other solid carriers.

Exemplary preservatives include, for example, 1,2-benzisothiazolin-3-one and/or 2-methyl-2H-isothiazol-3-one or sodium benzoate or benzoic acid.

The herbicidal combinations and compositions of the present disclosure can be in any conventional agriculturally useful form, for example, in the form of a ready-to-use formulation, or in the form of a tank mix.

In an embodiment, the herbicidal actives may be formulated as a premix product or a ready-to-use product. In an embodiment, the method comprises applying the present combinations or compositions simultaneously, that is jointly or separately, or in succession. In another embodiment, the constituents of the combination of the present disclosure may be tank mixed and applied or sprayed at the locus of the infection or may be alternatively mixed with surfactants and/or any other agrochemically suitable excipients and then applied. In yet another embodiment, the constituents of the combination of the present disclosure may be applied in such quick succession in any order so as to form the desired mix at the locus of application. In an embodiment, the constituents of the composition of the present disclosure may be used for foliar application, ground application, or application to plant propagation materials.

The combination or tank-mix of L-glufosinate or a salt thereof and the choline salt of 2,4-D also includes a combination or a mixture of a composition comprising L-glufosinate or a salt thereof and a composition comprising the choline salt of 2,4-D. Each individual composition may comprise one or more agrochemically suitable excipient/ingredients. The resulting combination or tank-mix of the composition comprising L-glufosinate or a salt thereof and the composition comprising the choline salt of 2,4-D provides a synergistic effect in controlling the weeds.

In an embodiment, the composition may be in any agriculturally suitable form for storage and application to the ground. The compositions of the present disclosure may typically be produced by mixing the actives in the composition with an inert carrier, and adding surfactants and other adjuvants and carriers as needed and formulated into solid, or liquid formulations, including but not limited to wettable powders, granules, dusts, soluble (liquid) concentrates, suspension concentrates, oil in water emulsion, water in oil emulsion, emulsifiable concentrates, capsule suspensions, ZC formulations, oil dispersions, or other known formulation types. The composition may also be used for treatment of a plant propagation material such as seeds, and the like.

In another embodiment, the compositions of the present disclosure further include an additional agrochemical/pesticide. Examples of pesticides include, but are not limited to, herbicides, fungicides, miticides, larvicides, avicides, insecticides, nematicides, and rodenticides.

According to an embodiment, the combinations and/or compositions of the present disclosure may be further combined or applied with an additional herbicide.

According to an embodiment, the present disclosure provides a composition comprising L-glufosinate or a salt thereof, a choline salt of 2,4-D, and an additional herbicide.

Non-limiting examples of the additional herbicide include 2,4-D, anisiflupurin, acetochlor, aclonifen, amicarbazone, halauxifen, halauxifen-methyl, florpyrauxifen, amidosulfuron, aminocyclopyrachlor, aminopyralid, aminotriazole, ammonium thiocyanate, anilofos, asulam, azimsulfnron, atrazine, beflubutamid, benazolin, benfuresate, bensulfuron-methyl, bentazon-sodium, benzofenap, bifenox, bixlozone, benquitrione, bipyrazone, bispyribacsodium, bromobutide, bromacil, bromoxynil, butachlor, butafenacil, butralin, butroxydim, carbetamide, cafenstrole, carfentrazone, carfentrazone-ethyl, chlormequat, clopyralid, chlorsulfuron, chlortoluron, cinidon-ethyl, clethodim, clodinafop-propargyl, clomeprop, clomazone, cloransulam-methyl, cyanazine, cyclopyrimorate, cyclosulfamuron, cycloxydim, cyhalofop-butyl, cypyrafluone, daimuron, dicamba, dichlobenil, dichlorprop-P, diclofop-methyl, diclosulam, diflufenican, diflufenzopyr, dimefuron, dimethachlor, diquat, dioxopyritrione, diuron, 5-ethyl dipropylcarbamothioate (EPTC), esprocarb, ethoxysulfuron, etobenzanid, fenoxaprop, fenoxaprop-ethyl, fenoxapropethyl+isoxadifen-ethyl, fenoxaprop-P-ethyl, fenoxasulfone, fenquinotrione, fentrazamide, fenpyrazone, flazasulfuron, florasulam, fluazifop, fluazifop-P-butyl, flucarbazone, flucarbazone-sodium, flucetosulfuron (LGC-42153), flufenacet, flumetsulam, flumioxazin, flupyrsulfuron, flurochloridone, fluroxypyr, fluroxypyr-meptyl, flurtamone, glufosinate, glufosinate-ammonium, glyphosate, halosulfuron-methyl, haloxyfop-methyl, haloxyfop-R-methyl, hexazinone, imazamethabenz, imazamox, imazapic, imazapyr, imazaquin, imazethapyr, imazosulfuron, indanofan, indaziflam, iodosulfuron, iodosulfuron-ethyl-sodium, iofensulfuron, ioxynil, ipfencarbazone, isoproturon, isoxaben, isoxaflutole, lactofen, linuron, 2-methyl-4-chlorophenoxyacetic acid (MCPA), 4-(4-chloro-2-methylphenoxy)butanoic acid (MCPB), mecoprop-P, mefenacet, mesosulfuron, mesosulfuron-ethyl sodium, mesotrione, metamifop, metazochlor, metazosulfuron, metosulam, metribuzin, metsulfuron, metsulfuronmethyl, molinate, monosodium methanearsonate (MSMA), napropamide, napropamide-M, orfurazon, orthosulfamuron, oryzalin, oxadiargyl, oxadiazon, oxazichlomefone, oxyfluorfen, paraquat, pendimethalin, penoxsulam, pentoxazone, pethoxamid, picloram, picolinafen, pinoxaden, pretilachlor, primisulfuron, profluazol, profoxydim, propanil, propaquizafop, propyrisulfuron, propoxycarbazone, propyzamide, prosulfocarb, prosulfuron, pyraclonil, pyraflufen-ethyl, pyrasulfotole, pyrazosulfuron-ethyl, pyrazolynate, pyribenzoxim (LGC-40863), pyributicarb, pyridate, pyriftalid, pyrimisulfan, pyroxsulam, pyroxasulfone, quinclorac, quinmerac, quizalofop-ethyl-D, quizalofop-P-ethyl, quizalofop-P-tefuryl, rimsulfuron, rimisoxafen, sethoxydim, simazine, sulcotrione, sulfentrazone, sulfometuron, sulfosate, sulfosulfuron, tebuthiuron, tefuryltrione, tepraloxidim, terbacil, terbuthylazine, terbutryn, tetflupyrolimet, thenylchlor, thiazopyr, thifensulfuron, thifensulfuron-methyl, thiobencarb, topramezone, tralkoxydim, triafamone, triasulfuron, tribenuron, tribenuron-methyl, triafamone, triclopyr, tripyrasulfone, SL-1201, cyclopyranil, dimesulfazet, epyrifenacil, tembotrione, thiencarbazone methyl, flucetosulfuron, pyrasulfotole, saflufenacil, pyraclonil, fenquinotrione, tiafenacil, cinmethylin, lancotrione-sodium, trifludimoxazin, cyclopyrimorate, methiozolin, aminocyclopyrachlor, bicyclopyrone, triafamone, tolpyralate. trifluralin, and agriculturally acceptable salts, choline salts, esters and mixtures thereof.

In an embodiment, if the additional herbicide is 2,4-D, it is present in a form other than the choline salt.

In another aspect, present compositions may further comprise a safener. In an embodiment, the safener includes, but is not limited to, isoxadifen-ethyl, cloquintocet-mexyl, mefenpyr-diethyl, naphthalic anhydride, oxabetrinil, benzenesulfonamide, N-(aminocarbonyl)-2-chlorobenzene sulfonamide (2-CBSU), daimuron, dichloroacetamide, dicyclonon, fenchlorazole-ethyl, fenclorim, fluxofenim, dichloroacetamide safeners (e.g., AD-67, benoxacor, dichlormid, and furilazole), naphthopyranone, naphthalic anhydride (NA), oxime, phenylpyrimidine, phenylurea, phenyl pyrazoles compounds, naphthalic anhydride, cyometrinil, flurazole, dimepiperate, methoxyphenone, cloquintocet-mexyl, 1-dichloroacetylhexahydro-3,3,8α-trimethylpyrrolo[1,2-a]pyrimidin-6-(2H-one), dichloromethyl-1,3-dioxolane, quinolinyloxyacetate compounds, or agriculturally acceptable salts, esters, or mixtures thereof.

In accordance with another embodiment of the disclosure, there is provided a process for preparing a composition comprising L-glufosinate or a salt thereof and 2,4-D choline. The process involves the addition of an agrochemically suitable excipient to the herbicidal actives. Optionally, it includes addition of an additional herbicide to the mixture. The resulting composition is storage stable with a convenient shelf-life.

According to another embodiment, there is provided a use of a combination comprising L-glufosinate or a salt thereof and a choline salt of 2,4-D to control, eradicate, or prevent weed growth.

According to another embodiment, there is provided a use of a composition comprising L-glufosinate or a salt thereof and a choline salt of 2,4-D to control, eradicate or prevent weed growth.

The combinations and compositions of the present disclosure can be used in agricultural lands such as fields, paddy fields, lawns and orchards or in non-agricultural lands. The combinations described herein may be used to control weeds in agricultural lands for cultivating the crops without any phytotoxicity to the crops. Examples of the crops on which the combinations and compositions of the present disclosure may be used include, but are not limited to, corn, rice, wheat, barley, rye, oat, sorghum, cotton, soybean, peanut, buckwheat, beet, rapeseed, sunflower, sugar cane, tobacco, etc.; solanaceous vegetables such as eggplant, tomato, pimento, pepper, potato, etc.; cucurbit vegetables such as cucumber, pumpkin, zucchini, water melon, melon, squash, etc.; cruciferous vegetables such as radish, white turnip, horseradish, kohlrabi, Chinese cabbage, cabbage, leaf mustard, broccoli, cauliflower, etc.; asteraceous vegetables such as burdock, crown daisy, artichoke, lettuce, etc; liliaceous vegetables such as green onion, onion, garlic, and asparagus; ammiaceous vegetables such as carrot, parsley, celery, parsnip, etc.; chenopodiaceous vegetables such as spinach, Swiss chard, etc.; lamiaceous vegetables such as Perilla frutescens, mint, basil, etc, strawberry, sweet potato, Dioscorea japonica, colocasia, etc.; flowers, foliage plants, turf grasses; pome fruits such apple, pear, quince, etc.; stone fleshy fruits such as peach, plum, nectarine, Prunus mume, cherry fruit, apricot, prune, etc.; citrus fruits such as orange, lemon, rime, grapefruit, etc.; nuts such as chestnuts, walnuts, hazelnuts, almond, pistachio, cashew nuts, macadamia nuts, etc.; berries such as blueberry, cranberry, blackberry, raspberry, etc.; grape, kaki fruit, olive, plum, banana, coffee, date palm, coconuts, etc.; trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, and the like.

In a preferred embodiment, the combinations and/or compositions of the present disclosure are used to control weeds in crops selected from the group of drybeans, sunflower, sorghum, rice, canola, cereals, peanuts, pulses, and sugarcane.

In a preferred embodiment, the combinations and/or compositions of the present disclosure are used to control weeds in pasture, plantations, trees, vines, and nuts.

According to an embodiment, there is provided a method of controlling weeds at a locus comprising applying to the said locus, a combination comprising L-glufosinate or a salt thereof and a choline salt of 2,4-D.

In an embodiment, said combination is synergistic.

According to an embodiment, there is provided a method of controlling weeds at a locus comprising applying to the said locus a composition comprising L-glufosinate or a salt thereof and a choline salt of 2,4-D.

The combinations and compositions of the present disclosure are used to control weeds in various agricultural crops. Non-limiting examples of weeds controlled by the compositions of the present invention include:
Urticaceae weeds: Urtica urens;
Polygonaceae weeds: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifolius, Rumex acetosa; Portulacaceae weeds: Portulaca oleracea; Caryophyllaceae weeds: Stellaria media, Cerastium holosteoides, Cerastium glomeratum, Spergula arvensis, Silene gallica;
Molluginaceae weeds: Mollugo verticillata; Chenopodiaceae weeds: Chenopodium album, Chenopodium ambrosioides, Kochia scoparia, Salsola kali, Atriplex spp.; Amaranthaceae weeds: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, Alternanthera tenella; Papaveraceae weeds: Papaver rhoeas, Argemone Mexicana; Brassicaceae weeds;
Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, Coronopus didymus; Dinebra weeds: Dinebra americana, Dinebra aquatic, Dinebra aristidoides, Dinebra bromoides, Dinebra calycina, Dinebra caudata, Dinebra chinensis, Dinebra chloride, Dinebra chondrosioides, Dinebra coerulescens, Dinebra cristata, Dinebra curtipendula, Dinebra decipiens, Dinebra divaricate, Dinebra divaricatissima, Dinebra dura, Dinebra guineensis, Dinebra hirsute, Dinebra hirta, Dinebra juncifolia, Dinebra ligulata, Dinebra lima, Dinebra melicoides, Dinebra nealleyi, Dinebra neesii, Dinebra panicea, Dinebra panicoides, Dinebra pubescens, Dinebra repens, Dinebra scabra, Dinebra secunda, Dinebra simoniana, Dinebra southwoodii, Dinebra squarrosa, Dinebra srilankensis, Dinebra tuaensis, Dinebra verticillate, Dinebra retroflexa. Dinebra haareri, Dinebra marquisensis, Dinebra perrieri, Dinebra polycarpha, Dinebra somalensis, Capparaceae weeds: Cleome affinis; Fabaceae weeds: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsuta, Indigofera truxillensis, Vigna sinensis; Oxalidaceae weeds: Oxalis corniculata, Oxalis strica, Oxalis oxyptera; Geraniaceae weeds: Geranium carolinense, Erodium cicutarium; Euphorbiaceae weeds: Euphorbia helioscopia, Euphorbia maculate, Euphorbia humistrata, Euphorbia esula, Euphorbia heterophylla, Euphorbia brasiliensis, Acalypha australis, Croton glandulosus, Croton lobatus, Phyllanthus corcovadensis, Ricinus communis; Malvaceae weeds: Corchorus, Abutilon theophrasti, Sida rhombiforia, Sida cordifolia, Sida spinosa, Sida glaziovii, Sida santaremnensis, Hibiscus trionum, Anoda cristata, Malvastrum coromandelianum;
Sterculiaceae weeds: Waltheria indica; Violaceae weeds: Viola arvensis, Viola tricolor; Cucurbitaceae weeds: Sicyos angulatus, Echinocystis lobata, Momordica charantia; Lythraceae weeds: Lythrum salicaria; Apiaceae weeds: Hydrocotyle sibthorpioides; Sapindaceae weeds: Cardiospermum halicacabum; Primulaceae weeds: Anagallis arvensis; Asclepiadaceae weeds: Asclepias syriaca, Ampelamus albidus; Rubiaceae weeds: Galium aparine, Galium spurium var. echinospermon, Spermacoce latifolia, Richardia brasiliensis, Borreria alata, Borreria verticilata; Convolvulaceae weeds: Ipomoea alba, Ipomoea nil, Ipomoea hederacea, Ipomoea purpurea, Ipomoea hederacea var. integriuscula, Ipomoea lacunosa, Ipomoea triloba, Ipomoea acuminata, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoides, Jacquemontia tamnifolia; Boraginaceae weeds: Myosotis arvensis; Lamiaceae weeds: Lamium purpureum, Lamium amplexicaule, Leonotis nepetaefolia, Hyptis suaveolens, Hyptis lophanta, Leonurus sibiricus, Stachys arvensis; Solanaceae weeds: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, Nicandra physaloides; Scrophulariaceae weeds: Veronica hederaefolia, Veronica persica, Veronica arvensis; Plantaginaceae weeds: Plantago asiatica; Asteraceae weeds: Xanthium pensylvanicum, Xanthium occidentale, Helianthus annuus, Matricaria chamomilla, Matricaria perforata, Chrysanthemum segetum, Matricaria matricarioides, Artemisia princeps, Artemisia vulgaris, Artemisia verlotorum, Solidago altissima, Taraxacum officinale, Galinsoga ciliata, Galinsoga parviflora, Senecio vulgaris, Senecio brasiliensis, Senecio grisebachii, Conyza bonariensis, Conyza canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, Soliva sessilis; Liliaceae weeds: Allium canadense, Allium vineale; Commelinaceae weeds: Cyanotis axillaris, Commelina communis, Commelina benghalensis, Commelina erecta; Poaceae weeds: Dinebra retroflexa, Cynodon dactylon, Echinochloa colonum, Echinochloa crusgalli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spicaventi, Panicum dichotomiflorum, Panicum texanum, Panicum maximum, Brachiaria reptains Brachiaria platyphylla, Brachiaria ruziziensis, Brachiaria plantaginea, Brachiaria decumbens, Brachiaria brizantha, Brachiaria humidicola, Brachiaria mutica, Cenchrus echinatus, Cenchrus pauciflorus, Eriochloa villosa, Pennisetum setosum, Chloris gayana, Chloris barbata, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, Rottboellia cochinchinensis; Cyperaceae weeds: Cyperus microiria, Cyperus iria, Cyperus odoratus, Cyperus rotundus, Cyperus esculentus, Kyllinga gracillima, Equisetaceae weeds: Equisetum arvense, Equisetum palustre, Trianthema weeds, and the like.

According to an embodiment, the weeds targeted by the combinations and compositions of the present disclosure are grassy weeds and broad-leaved weeds.

It was surprisingly found that the combinations of the present disclosure were effective and showed synergistic control over resistant varieties of weeds.

In an embodiment, the combinations or the compositions according to the present disclosure may be used for burndown application or fallow application.

In an embodiment, the weed removal is not restricted to crop land or agricultural land only. The weeds may be targeted in non-agricultural areas such as, but not limited to, forestries, railways, infrastructure, amenities, companies, factories, roads and runways, sidewalks, highways, dividers, medians, pipelines, public utility lines, pumping stations, transformer stations, substations, around airports, electric utilities, commercial buildings, manufacturing plants, storage yards, rail yards, hangars, fence lines, parking lots, parkways, sedges, post-harvest crop lands, beneath greenhouse benches, and around golf courses.

According to an embodiment, there is provided a method of application of a combination or a composition comprising L-glufosinate or a salt thereof and a choline salt of 2,4-D for control, eradication or prevention of weed growth.

The combination of the present disclosure maybe applied simultaneously as a tank mix or a premix formulation or may be applied sequentially. The application may be made to the soil before emergence of the plants, either pre-planting or post-planting. The application may be made to the soil after emergence of the plants. The application may be made as a foliar spray at different timings during crop development, with either one or more applications early or late post-emergence.

Herbicidal compositions according to the invention can also be incorporated into the soil before, during or after sowing seeds of a crop. These combinations as described above may be applied to the locus of the weeds, in an herbicidally effective amount.

In an embodiment, L-glufosinate or salts thereof is applied to a target locus at a rate of about 1-3000 g active ingredient per hectare (a.i./ha).

In an embodiment, L-glufosinate or salts thereof is applied to a target locus at a rate of about 1-2000 g a.i./ha.

In an embodiment, L-glufosinate or salts thereof is applied to a target locus at a rate of about 1-1000 g a.i./ha.

In an embodiment, L-glufosinate or salts thereof is applied to a target locus at a rate of about 1-500 g a.i./ha.

In an embodiment, L-glufosinate or salts thereof is applied to a target locus at a rate of about 100-500 g a.i./ha.

In an embodiment, L-glufosinate or salts thereof is applied to a target locus at a rate of about 100-300 g a.i./ha.

In an embodiment, choline salt of 2,4-D is applied to a target locus at a rate of about 1-3000 g a.i./ha.

In an embodiment, choline salt of 2,4-D is applied to a target locus at a rate of about 1-2000 g a.i./ha.

In an embodiment, choline salt of 2,4-D is applied to a target locus at a rate of about 1-1000 g a.i./ha.

In an embodiment, choline salt of 2,4-D is applied to a target locus at a rate of about 1-500 g a.i./ha.

In an embodiment, L choline salt of 2,4-D is applied to a target locus at a rate of about 100-500 g a.i./ha.

In an embodiment, choline salt of 2,4-D is applied to a target locus at a rate of about 100-300 g a.i./ha.

When applied to the target locus, L-glufosinate or salts thereof is applied at a rate of 1-1000 g a.i./ha, in association with 1-1000 g a.i./ha of 2,4-D choline.

The combinations and the compositions of the present disclosure may be applied in any known ways or conventional methods known to a person skilled in art. Non-limiting examples of such methods are foliar spray, basal barking, stem injection, drill and fill method, axe cut method, cut stump, cut and swab, stem scraper, wick application and so forth. The compositions of the present disclosure may be used in the customary manner, for example by watering, spraying, atomizing, dusting or scattering. The combinations and the compositions of the present disclosure can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots, and by other conventional means known to those skilled in the art.

Typically, for the product of the present disclosure, the composition is applied at a rate ranging from 1-1000 kg active compound/ha. The weight ratios of individual components can be varied within relatively wide ranges. Typically, there are 1:1000 to 1000:1 parts by weight of the active compounds.

The combinations of the present disclosure may be developed as a pre-mix composition or a kit of parts such that individual actives may be mixed before applying.

Thus, an embodiment of the present disclosure provides a kit-of-parts comprising a component of L-glufosinate or a salt thereof and a second component of a choline salt of 2,4-D. In an embodiment, one of the two components or both may be admixed with an agrochemically suitable excipient. Optionally, the kit-of-parts may comprise an additional herbicide as a third component or in a pre-mix with either of the two herbicidal components of the composition. The kit-of-parts may further comprise a component including an agrochemically suitable excipient. The kit of parts may contain either of the L-glufosinate herbicide or a salt thereof and the choline salt of 2,4-D previously admixed, individually or together, with an adjuvant or an agrochemically suitable excipient such that the two components may be tank mixed before applying. The kit-of-parts may be further accompanied by a set of instructions in form of a manual, guide, booklet, pamphlet, and so forth.

These combinations or compositions as described above may be applied to the weed or to locus of the weeds or to the plant/crop, in synergistically effective amounts. It can be seen from the examples herein that the herbicidal action of the active compound combinations according to the disclosure exceeds the calculated value, that is to say, that the new active compound combinations have a synergistic effect in controlling weeds.

This effectiveness of all treatments can be evaluated according to Colby's equation. In Colby's equation given below,
E is the expected efficacy of combination of L-glufosinate or a salt thereof and 2,4-D choline:
X is the observed efficacy of L-glufosinate or a salt thereof, and
Y is the observed efficacy of 2,4-D choline.

Observed efficacy values, i.e., X and Y, are % weed control for L-glufosinate or salts thereof and 2,4-D choline. If the observed efficacy of combination of L-glufosinate or a salt thereof and 2,4-D choline is greater than the expected efficacy, then combination is determined to be synergistic. If observed efficacy is equal to or less than expected efficacy, then combination is determined to be non-synergistic.

E=X+Y−XY/100 Colby's equation:

The result of synergistic effects of the present combinations/compositions is represented in the examples. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth.

Specifically, the invention includes embodiments in which particular subject matter is excluded, in full or in part, such as substances or materials, method steps and conditions, protocols, procedures, assays or analysis. Thus, even though the invention is generally not expressed herein in terms of what the invention does not include aspects that are not expressly included in the invention are nevertheless disclosed herein. A number of embodiments of the invention have been described.

Nevertheless, it will be understood that various modifications may be made without departing from the spirit and scope of the invention.

These and other advantages of the invention may become more apparent from the examples set forth. These examples are provided merely as illustrations of the invention and are not intended to be construed as a limitation thereof.

Specifically, the invention includes embodiments in which particular subject matter is excluded, in full or in part, such as substances or materials, method steps and conditions, protocols, procedures, assays or analysis. Thus, even though the invention is generally not expressed herein in terms of what the invention does not include aspects that are not expressly included in the invention are nevertheless disclosed herein.

### EXAMPLES

The following examples demonstrate the present invention. The examples should not be construed as limiting and are simply illustrations of a ew of the many embodiments described herein.

Following active ingredient compounds were used to prepare combinations/compositions of L-glufosinate ammonium with 2,4-D choline.

| | Formulation | Dose | Dose |
|---|---|---|---|
| Active ingredient | type | a.i., g/L | a.i., g/ha |
| L-glufosinate | SL (soluble | 280 | 150 |
| ammonium | liquid) | | |
| 2,4-D choline | SL | 456 | 228 |
| 2,4-D choline | SL | 456 | 137 |

Methodology: Greenhouse trials were carried out to evaluate the efficacy of the combination of L-glufosinate and the choline salt of 2,4-D on the weeds Eleusine indica, Borreria verticilata, and Euphorbia heterophylla. The soil used was sandy clay loam—Sand: 68.0%; Silt: 8.0%; Clay: 24.0%. All treatments were in 3 replications per treatment with a spray volume of 150 L/h.

Evaluation: The expected efficacy of a combination of L-glufosinate ammonium and 2,4-D choline was calculated using the well-established Colby method. Any difference between the observed and “expected” efficacy could be attributed to synergy between the two compounds.

In the Colby method, the expected (or predicted) response of a combination of herbicides is calculated by taking the product of the observed response for each individual component of the combination when applied alone, divided by 100, and subtracting this value from the sum of the observed response for each component when applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective (Colby, S. R., Weeds, 1967(15), p. 20-22). The Colby method requires only a single dose of each herbicide applied alone and the mixture of both doses. The formula used to calculate the expected efficacy (EE) which was compared with the observed efficacy (OE) to determine the efficacy of the present invention is explained hereinbelow:

The expected efficacy for a combination of two active ingredients is as follows:

EE=(A+B−(A×B)/100)

The expected efficacy for a combination of three active ingredients is as follows:

EE=A+B+C−(AB+AC+BC)/100+ABC/10,000, Wherein, A=Observed efficacy of active ingredient A at the same concentration as used in the mixture; B=Observed efficacy of the active ingredient B at the same concentration as used in the mixture; and C=Observed efficacy of the active ingredient C at the same concentration as used in the mixture.

### Example 1: Efficacy of the Combination of L-Glufosinate Ammonium and 2,4-D Choline on Borreria verticilata

In this example, synergy from the combination of L-glufosinate ammonium (150 gai/ha) and 2,4-D choline (137 gai/ha) on Borrelia verticilata was determined using the calculated percentage efficacy after 7 days of application (DAA). The results are recorded in Table 1 below:

TABLE 1

| | | | Expected | Observed |
|---|---|---|---|---|
| | | | Efficacy* (%) | Efficacy (%) of |
| | | | of L-glufosinate | L-glufosinate |
| Observation at | Observed efficacy | | ammonium + | ammonium + |
| days after | (%) of L-glufosinate | Observed efficacy | 2,4-D choline | 2,4-D choline |
| application | ammonium(150 | (%) of 2,4-D choline | (150 + 137 | (150 + 137 |
| (DAA) | gai/ha) | (137 gai/ha) | gai/ha) | gai/ha) |
| 7 DAA | 65 | 30 | 75.5 | 90 |

*Expected efficacy according to Colby's Formula

In this example, synergy of the combination of L-glufosinate ammonium (150 gai/ha) and 2,4-D choline (228 gai/ha) on Borrelia verticilata was determined using the calculated percentage efficacy after 7 days of application (DAA). The results are recorded in the Table 2 below:

TABLE 2

| | | | Expected | Observed |
|---|---|---|---|---|
| | | | Efficacy* (%) of | Efficacy (%) of |
| | | | L-glufosinate | L-glufosinate |
| Observation | Observed efficacy | | ammonium + | ammonium + |
| at days after | (%) of L-glufosinate | Observed efficacy | 2,4-D choline | 2,4-D choline |
| application | ammonium (150 | (%) of 2,4-D choline | (150 + 228 | (150 + 228 |
| (DAA) | gai/ha) | (228 gai/ha) | gai/ha) | gai/ha) |
| 7 DAA | 65 | 30 | 75.5 | 80 |

*Expected efficacy according to Colby's Formula

### Example 2: Efficacy of the Combination of L-Glufosinate Ammonium and 2,4-D Choline on Eleusine indica

In this example, synergy of the combination of L-glufosinate ammonium (150 gai/ha) and 2,4-D choline (228 gai/ha) on Eleusine indica was determined using the calculated percentage efficacy after 7, 14, 21 and 28 days of application (DAA). The results are recorded in the Table 3 below:

TABLE 3

| | | | Expected | Observed |
|---|---|---|---|---|
| | | | Efficacy* (%) of | Efficacy (%) of |
| | | | L-glufosinate | L-glufosinate |
| Observation | Observed efficacy | | ammonium + | ammonium + |
| at days after | (%) of L-glufosinate | Observed efficacy | 2,4-D choline | 2,4-D choline |
| application | ammonium | (%) of 2,4-D choline | (150 + 228 | (150 + 228 |
| (DAA) | (150 gai/ha) | (228 gai/ha) | gai/ha) | gai/ha) |
| 7 DAA | 70 | 10 | 73 | 75 |
| 14 DAA | 65 | 10 | 68.5 | 75 |
| 21 DAA | 60 | 10 | 64 | 75 |
| 28 DAA | 50 | 5 | 52.5 | 80 |

*Expected efficacy according to Colby's Formula

### Example 3: Efficacy of Combination of L-Glufosinate Ammonium and 2,4-D Choline on Euphorbia heterophylla

In this example, synergy of the combination of L-glufosinate ammonium (150 gai/ha) and 2,4-D choline (137 gai/ha) Euphorbia heterophylla was determined using the calculated percentage efficacy after 7, 14, 21 days of application (DAA). The results are recorded in the Table 4 below:

TABLE 4

| | | | Expected | Observed |
|---|---|---|---|---|
| | | | Efficacy* (%) of | Efficacy (%) of |
| | | | L-glufosinate | L-glufosinate |
| Observation | Observed efficacy | | ammonium + | ammonium + |
| at days after | (%) of L-glufosinate | Observed efficacy | 2,4-D choline | 2,4-D choline |
| application | ammonium (150 | (%) of 2,4-D choline | (150 + 137 | (150 + 137 |
| (DAA) | gai/ha) | (137 gai/ha) | gai/ha) | gai/ha) |
| 7 DAA | 95 | 35 | 96.75 | 100 |
| 14 DAA | 98 | 30 | 98.6 | 100 |
| 21 DAA | 98 | 25 | 98.5 | 100 |

*Expected efficacy according to Colby's Formula

In this example, synergy of using the combination of L-glufosinate ammonium (150 gai/ha) and 2,4-D choline (228 gai/ha) on Euphorbia heterophylla was determined using the calculated percentage efficacy after 14, 21 days of application (DAA). The results are recorded in the Table 5 below:

TABLE 5

| | | | Expected | Observed |
|---|---|---|---|---|
| | | | Efficacy* (%) of | Efficacy (%) |
| | | | L-glufosinate | of L-glufosinate |
| Observation | Observed efficacy | | ammonium + | ammonium + |
| at days after | (%) of L-glufosinate | Observed efficacy | 2,4-D choline | 2,4-D choline |
| application | ammonium(150 | (%) of 2,4-D choline | (150 + 228 | (150 + 228 |
| (DAA) | gai/ha) | (228 gai/ha) | gai/ha) | gai/ha) |
| 14 DAA | 98 | 30 | 98.6 | 100 |
| 21 DAA | 98 | 30 | 98.6 | 100 |

*Expected efficacy according to Colby's Formula

From the above examples, it is evident that L-glufosinate ammonium and choline salt of 2,4-D showed synergistic effect in controlling a broad spectrum of weeds.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A synergistic herbicidal combination comprising L-glufosinate or a salt thereof, and a choline salt of 2,4-D.

2. The combination as claimed in claim 1, wherein the L-glufosinate or salt thereof, and the choline salt of 2,4-D are admixed in a ratio ranging from about 1:100 to 100:1.

3. The combination as claimed in claim 1, wherein the L-glufosinate salt is selected from L-glufosinate ammonium, L-glufosinate sodium, L-glufosinate potassium, and combinations thereof.

4. The combination as claimed in claim 1, wherein the herbicidal combination further comprises an additional herbicide.

5. An herbicidal composition comprising L-glufosinate or a salt thereof and a choline salt of 2,4-D.

6. The composition as claimed in claim 5, wherein the amount of L-glufosinate or salt thereof in the composition ranges from about 1 to 1000 g ai/L.

7. The composition as claimed in claim 5, wherein the amount of choline salt of 2,4-D in the composition ranges from about 1 to 2000 g ai/L.

8. The composition as claimed in claim 5, wherein the composition further comprises an agrochemically acceptable excipient.

9. The composition as claimed in claim 5, wherein the composition further comprises an additional herbicide.

10. A method of controlling weeds at a locus comprising:
applying to the locus the herbicidal combination of claim 1.

11. The method as claimed in claim 10, wherein applying the herbicidal combination is in the form of a premix, a tank-mix, a ready-to-use product or in succession.

12. The method as claimed in claim 10, wherein the weeds comprise grassy weeds and/or broadleaf weeds.

13. The method as claimed in claim 10, wherein the locus comprises crops selected from the group consisting of drybeans, sunflower, sorghum, rice, canola, cereals, peanuts, pulses, and sugarcane.

14. The method as claimed in claim 10, wherein the locus comprises pastures plantations, trees, vines and nuts.

15. The method as claimed in claim 10, wherein the application of the herbicidal combination comprises a burndown application or a fallow application.

16. The method as claimed in claim 10, wherein the herbicidal combination further comprises a third herbicide.

17. Use of an herbicidal combination according to claim 1 to control, eradicate or prevent weed growth.

18. A kit-of-parts for controlling weeds within a locus, the kit comprising a first component of L-glufosinate or a salt thereof and a second component of a choline salt of 2,4-D.
